(19) United States
(12) Patent Application Publication
(10) Pub. No.: US 2024/0213862 A1
(43) Pub. Date: Jun. 27, 2024

(54) HEAT TREATMENT FURNACE AND HEAT TREATMENT METHOD

(71) Applicants: TOYOTA BOSHOKU KABUSHIKI KAISHA, Kariya-shi (JP); KANTO YAKIN KOGYO CO., LTD., Hiratsuka-shi (JP)

(72) Inventors: Masaki SUGIYAMA, Kariya-shi (JP); Shinichi TAKAHASHI, Hiratsuka-shi (JP); Kensuke TAKAHASHI, Hiratsuka-shi (JP); Kiichi KANDA, Hiratsuka-shi (JP); Kosuke TAKAHARA, Hiratsuka-shi (JP); Kazuki FUNADA, Hiratsuka-shi (JP); Hiroshi OSHITA, Hiratsuka-shi (JP)

(21) Appl. No.: 18/531,088

(22) Filed: Dec. 6, 2023

(30) Foreign Application Priority Data
Dec. 27, 2022 (JP) 2022-210987

(51) Int. Cl. H02K 15/12; C21D 9/00

(52) U.S. Cl. CPC H02K 15/125; C21D 9/0062; C23C 8/18

(57) ABSTRACT

Provided is a heat treatment furnace used to anneal a workpiece to be heat-treated, including a heating chamber configured to heat the workpiece, a first cooling chamber and a second cooling chamber configured to cool the workpiece having passed through the heating chamber, and an atmosphere gas supply device configured to supply, as an in-furnace atmosphere gas, an exothermic converted gas to each of the first cooling chamber and the second cooling chamber, the first cooling chamber having a first cooling state of cooling the workpiece by using a first coolant and a second cooling state of cooling the workpiece by using not the first coolant but a second coolant different from the first coolant, and the second cooling chamber having a similar configuration to the first cooling chamber.

### CROSS-REFERENCE TO RELATED APPLICATION

This application is based upon and claims the benefit of priority from Japanese Patent Application No. 2022-210987, filed on Dec. 27, 2022; the entire contents of which are incorporated herein by reference.

### BACKGROUND

The present disclosure relates to a heat treatment furnace, and particularly to a heat treatment furnace and a heat treatment method which can be used for stress relief annealing of a motor core using electrical steel sheets.

In the past, electrical steel sheets have been used in electrical devices, for example, stationary devices such as transformers or rotary devices such as motors. For example, an iron core of a motor (motor core) is manufactured by blanking a non-oriented electrical steel sheet having a predetermined thickness into a stator shape or a rotor shape by use of a die and laminating the blanked materials.

When such an electrical steel sheet is blanked, however, what is called strain such as plastic strain or elastic strain may be left at end portions of a core material or around caulked portions thereof if the materials are caulked and laminated, in some cases. In order to remove such strain, stress relief annealing has hitherto been performed in the following manner. More specifically, the motor core is heated up to a temperature of approximately 750° C. to 850° C. in a non-oxidizing atmosphere gas such as carbon monoxide generated by incomplete combustion of nitrogen gas, argon gas, butane gas, or the like. Then, the motor core is cooled at a cooling rate of approximately 25° C./h, that is, cooled slowly. The motor core is cooled slowly so as to prevent strain from being placed on the motor core at the time of the cooling and prevent the dimensional accuracy from being degraded, thereby improving iron loss.

In addition, since the motor core is an electric conductor, when an alternating current flows in the motor core, an eddy current flows therein with a winding wire short-circuited. The eddy current is eventually converted into heat, leading to an eddy current loss. Hence, it is preferable that the eddy current be reduced as much as possible. In order to reduce the eddy current, it is preferable that, after the blanking, the laminated sheets be insulated from each other. To insulate the sheets, there is available a method of subjecting the sheets to a bluing treatment after the stress relief annealing to thereby oxidize cut/blanked end faces thereof (see, for example, Japanese Patent Laid-open No. 2015-42015). The bluing treatment is a treatment in which a dew point in a furnace is raised after the stress relief annealing to form an oxide film of iron (II) oxide (FeO), triiron tetraoxide (Fe₃O₄), or the like on surfaces of the steel sheets. By this bluing treatment, the surfaces of the steel sheet can be insulated, and the corrosion resistance and rust-preventive properties of the cut/blanked end faces thereof can be enhanced.

In Japanese Patent No. 6944146 proposed by the present inventors, on the other hand, there is disclosed a heat treatment method and a heat treatment furnace which make it possible to obtain, without performing the bluing treatment in the stress relief annealing of a motor core, characteristics at a comparable level to those obtained when the bluing treatment is performed. The heat treatment method in the heat treatment furnace includes an annealing step and a cooling step. In the annealing step, the motor core is heated or annealed by use of an exothermic converted gas as an in-furnace atmosphere gas. Then, in the cooling step, the motor core obtained upon the annealing step is cooled at a cooling rate in excess of 600° C. per hour at a temperature ranging from the temperature in the annealing step to 500° C., by use of the exothermic converted gas as the in-furnace atmosphere gas.

### SUMMARY

Incidentally, a workpiece to be heat-treated in the heat treatment furnace may have various sizes. For example, a thin workpiece and a thick workpiece are different from each other in cooling rate under the same cooling conditions.

It is desirable to provide a configuration which makes it possible to flexibly cope with characteristics of a workpiece to be heat-treated, such as a motor core, or contents of a treatment when stress relief annealing is performed on the workpiece.

According to a first aspect of the present disclosure, there is provided a heat treatment furnace used to anneal a workpiece to be heat-treated. The heat treatment furnace includes a heating chamber configured to heat the workpiece, a first cooling chamber configured to cool the workpiece having passed through the heating chamber, a second cooling chamber that is located on a downstream side of the first cooling chamber in a conveying direction of the workpiece and that is configured to cool the workpiece having passed through the first cooling chamber, and an atmosphere gas supply device configured to supply, as an in-furnace atmosphere gas, an exothermic converted gas to each of the first cooling chamber and the second cooling chamber. The first cooling chamber has a first cooling state of cooling the workpiece by using a first coolant and a second cooling state of cooling the workpiece by using not the first coolant but a second coolant different from the first coolant, and the second cooling chamber has a third cooling state of cooling the workpiece by using a third coolant and a fourth cooling state of cooling the workpiece by using not the third coolant but a fourth coolant different from the third coolant.

For example, the first cooling chamber may include a first coolant channel through which a first coolant flows and a second coolant channel through which a second coolant flows, and the first coolant channel may have a common part with the second coolant channel. In addition, for example, the second cooling chamber may include a third coolant channel through which a third coolant flows and a fourth coolant channel through which a fourth coolant flows, and the third coolant channel may have a common part with the fourth coolant channel. Preferably, the third coolant is the first coolant, and the fourth coolant is the second coolant.

Preferably, the atmosphere gas supply device selectively supplies a first gas that is an exothermic converted gas and a second gas that is an exothermic converted gas and that has a dew point lower than a dew point of the first gas.

Preferably, the atmosphere gas supply device is operated to supply the first gas to at least either the first cooling chamber or the second cooling chamber when a bluing treatment is to be performed on the workpiece.

Preferably, the atmosphere gas supply device is operated to supply the second gas to at least either the first cooling chamber or the second cooling chamber when a pseudo-bluing treatment is to be performed on the workpiece.

Preferably, the workpiece is a motor core.

In addition, according to the second aspect of the present disclosure, there is provided a heat treatment method in annealing a workpiece to be heat-treated. The method includes heating the workpiece, and cooling the heated workpiece by selectively supplying, as an in-furnace atmosphere gas, a first gas that is an exothermic converted gas and a second gas that is an exothermic converted gas and that has a dew point lower than a dew point of the first gas. When a bluing treatment is to be performed, the first gas is supplied as the in-furnace atmosphere gas, and the workpiece is cooled at a first cooling rate by using not a first coolant but a second coolant different from the first coolant. When a pseudo-bluing treatment is to be performed, the second gas is supplied as the in-furnace atmosphere gas, and the workpiece is cooled at a second cooling rate in excess of 600° C. per hour by using the first coolant. The second cooling rate is higher than the first cooling rate.

According to the first aspect and the second aspect of the present disclosure, it is possible to flexibly cope with the characteristics of the workpiece to be heat-treated, such as the motor core, or the contents of the treatment when the stress relief annealing is performed on the workpiece.

### BRIEF DESCRIPTION OF THE DRAWINGS

FIG. 1 is a schematic diagram depicting the configuration of a heat treatment furnace according to one embodiment of the present disclosure;

FIG. 2A is a sectional schematic view of a first cooling chamber of the heat treatment furnace of FIG. 1;

FIG. 2B is a sectional schematic view of a modification of the first cooling chamber of FIG. 2A;

FIG. 3 is a graph depicting a relation between a mixing ratio of air and a fuel gas and a component ratio of a converted gas generated upon combustion of the air and the fuel gas;

FIG. 4 is a configuration diagram depicting a flow of a converted gas from an atmosphere gas supply device of the heat treatment furnace of FIG. 1 and a configuration therefor;

FIG. 5 is a flow chart of a heat treatment in the heat treatment furnace of FIG. 1; and

FIG. 6 is a flow chart concerning the selection of an in-furnace atmosphere gas and a cooling mechanism used in a cooling chamber of the heat treatment furnace of FIG. 1.

### DETAILED DESCRIPTION OF THE PREFERRED EMBODIMENT

A heat treatment furnace and a heat treatment method in the heat treatment furnace according to one embodiment of the present disclosure will be described with reference to the drawings.

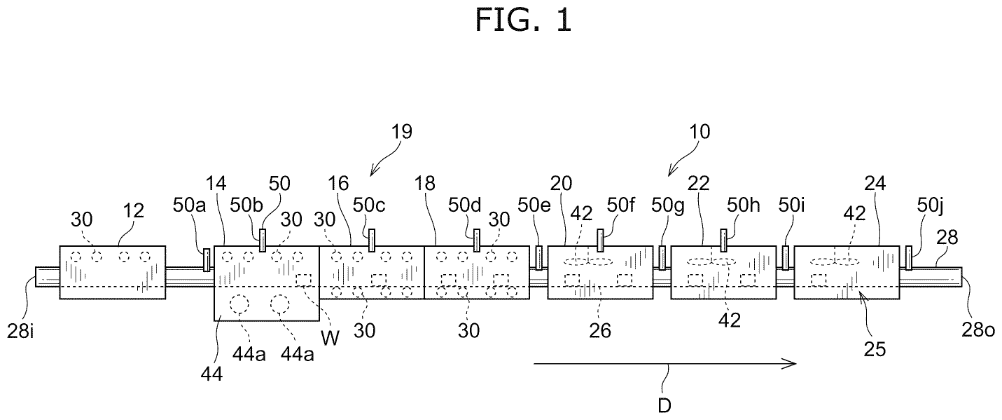

FIG. 1 depicts a schematic configuration diagram of a heat treatment furnace 10 according to the one embodiment of the present disclosure. The heat treatment furnace 10 includes a burn-off furnace 12, a preheating chamber 14, a heating chamber 16, a retaining chamber 18, a first cooling chamber 20, a second cooling chamber 22, and a third cooling chamber 24. The burn-off furnace 12 and the chambers are aligned in a conveying direction D of a workpiece W to be heat-treated. A tunnel 28 extends continuously over the burn-off furnace 12, the preheating chamber 14, the heating chamber 16, the retaining chamber 18, the first cooling chamber 20, the second cooling chamber 22, and the third cooling chamber 24. The tunnel 28 is a conveying channel through which the workpiece W is conveyed by a conveying device 25 i.e., on a mesh belt 26 driven by an unillustrated motor. Note that the tunnel 28 is opened to the exterior at an upstream end inlet 28i and a downstream end outlet 280. However, the tunnel 28 may also be opened to the exterior at any point in the middle of the tunnel 28, for example, at a point between the burn-off furnace 12 and the preheating chamber 14. The mesh belt 26 may be a hearth roller.

The burn-off furnace 12 can also be referred to as, for example, a burn-off chamber or a degreasing chamber and is provided to remove oil or the like deposited on a surface of the workpiece W. Here, the workpiece W is an iron core of a motor (a motor core), but may be other than the motor core. The burn-off furnace 12 includes heaters 30 as heating mechanisms for burning or evaporating the oil or the like. In this example, a plurality of heaters 30 are provided in the burn-off furnace 12. However, the number of the heaters 30 is not other to a particular number and may be one or more. Note that, in place of or in addition to the heaters 30, a fan or the like may be provided in the burn-off furnace 12.

Each of the preheating chamber 14 and the heating chamber 16 is configured to heat the workpiece W. A plurality of heaters 30 are provided in each of the preheating chamber 14 and the heating chamber 16, but the number of the heaters 30 is not limited to a particular number and may be one or more. The retaining chamber 18 is also configured to heat the workpiece W and includes a plurality of heaters 30. However, the number of the heaters 30 is not limited to a particular number and may be one or more. The preheating chamber 14 and the heating chamber 16 communicate directly with each other, and the heating chamber 16 and the retaining chamber 18 communicate directly with each other. Hence, the preheating chamber 14, the heating chamber 16, and the retaining chamber 18 may be deemed as a single heating chamber 19. Note that the retaining chamber 18 can retain the temperature of the workpiece W by adjusting the operations of the plurality of heaters 30. Also, the retaining chamber 18 can further heat the workpiece W or cool the workpiece W having passed through the heating chamber 16, by putting some or all of the plurality of heaters 30 into a non-operating state, that is, by turning them off. It is preferable that ON/OFF states of the respective heaters 30 be controlled such that the temperatures in the chambers 14, 16, and 18 in which the heaters 30 are disposed become target temperatures.

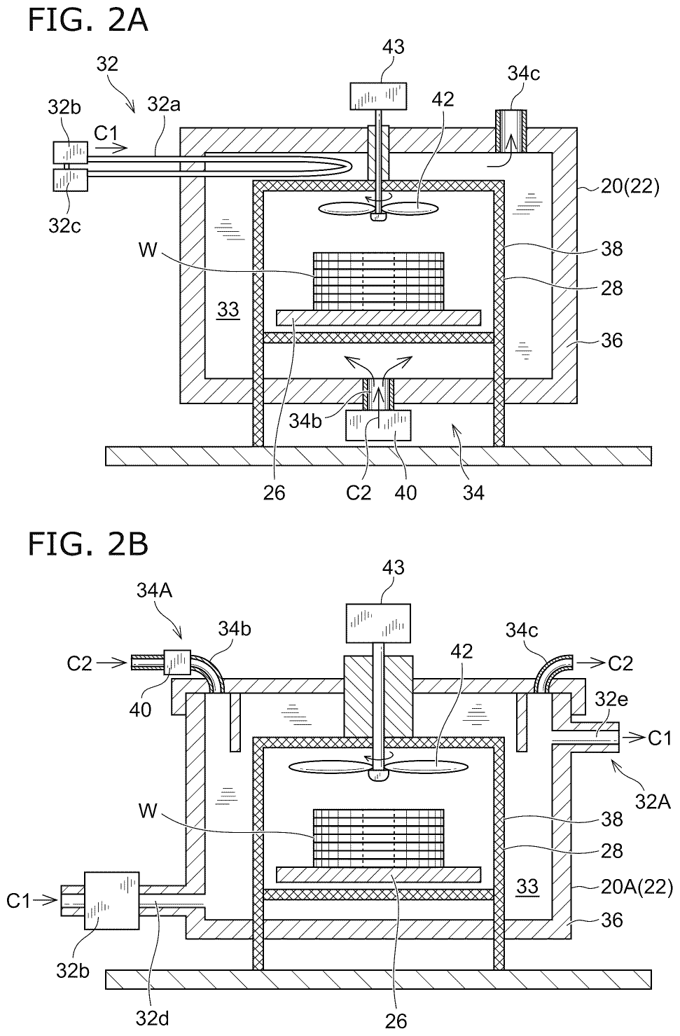

A sectional schematic view of the first cooling chamber 20 is depicted in FIG. 2A. FIG. 2A is a sectional view of the first cooling chamber 20 in a virtual plane orthogonal to the conveying direction D. The first cooling chamber 20 is configured to cool the workpiece W having passed through the heating chamber 19, more specifically, the workpiece W having passed through the heating chamber 16 and the retaining chamber 18. Hence, the first cooling chamber 20 has no heating source. The first cooling chamber 20 includes switchable cooling mechanisms. The first cooling chamber 20 has a first cooling state of cooling the workpiece W by using a first coolant C1, and a second cooling state of cooling the workpiece W by using not the first coolant C1 but a second coolant C2 different from the first coolant C1. The first cooling chamber 20 has a first cooling mechanism 32 which uses the first coolant C1, and a second cooling mechanism 34 which uses the second coolant C2. In the periphery of the conveying channel or the tunnel 28 which is to be supplied with an in-furnace atmosphere gas to be described later, a coolant channel 33 to be supplied with a cooling medium (coolant) is defined. Assuming that an inner space in the tunnel 28 to be supplied with the in-furnace atmosphere gas is an inner chamber, the coolant channel 33 may be regarded as an outer chamber. The coolant channel 33 is defined between an outer wall 36 and a furnace partition wall 38 of the tunnel 28. In this way, the coolant channel 33 to be supplied with the coolant is different from the conveying channel to be supplied with the in-furnace atmosphere gas. Accordingly, the coolant such as the first coolant C1 and the second coolant C2 is different from the in-furnace atmosphere gas. As depicted in FIG. 2A, the furnace partition wall 38 of the tunnel 28 has a rectangular sectional shape, and the outer wall 36 has a rectangular sectional shape on the outside of the furnace partition wall 38. The outer wall 36 is spaced apart from the furnace partition wall 38 of the tunnel 28 and is disposed to cover the whole circumference of the furnace partition wall 38 of the tunnel 28. However, at least part of the outer wall 36 may also have any of various sectional shapes on the outside of the furnace partition wall 38 in such a manner as to define the coolant channel 33 between the outer wall 36 and the furnace partition wall 38. Each of the outer wall 36 and the furnace partition wall 38 is formed of stainless steel, and SUS316L or SUS304L is used as its material, for example. However, the material is not limited thereto, and the outer wall 36 and the furnace partition wall 38 may be formed of any other material.

The first cooling mechanism 32 includes a cooling pipe 32a extending inside the coolant channel 33, a pump 32b for circulating the first coolant C1 in the cooling pipe 32a, and a cooler 32c for cooling the first coolant C1. The pump 32b and the cooler 32c are provided outside the outer wall 36 and at those portions of the cooling pipe 32a which extend outside the outer wall 36. The first coolant C1 may not be circulated in the cooling pipe 32a but may flow through the cooling pipe 32a. The cooler 32c may have any of various known cooling configurations. Note that, while the single cooling pipe 32a is depicted in FIG. 2A, the number of the cooling pipes 32a extending inside the coolant channel 33 may be two or more. Note that the cooling pipe 32a corresponds to a first coolant channel in which the first coolant C1 is made to flow.

The second cooling mechanism 34 includes a pump 40 for feeding the second coolant C2 under pressure. The pump 40 is provided on the upstream side of a coolant inlet (hereinafter referred to as a second coolant inlet) 34b such that the second coolant C2 is introduced into the coolant channel 33 via the second coolant inlet 34b and is then fed out from the coolant channel 33 via a coolant outlet (hereinafter referred to as a second coolant outlet) 34c. The second coolant inlet 34b is formed in the outer wall 36 to introduce the second coolant C2 via a portion of the coolant channel 33 on the lower side in the vertical direction, and the second coolant outlet 34c is formed in the outer wall 36 to feed out the second coolant C2 via a portion of the coolant channel 33 on the upper side in the vertical direction. However, the positions of the second coolant inlet 34b and the second coolant outlet 34c are not limited to the above positions. For example, both the second coolant inlet 34b and the second coolant outlet 34c can be provided at portions of the coolant channel 33 on the upper side in the vertical direction or at portions of the coolant channel 33 on the lower side in the vertical direction. Note that the coolant channel 33 corresponds to a second coolant channel in which the second coolant C2 is made to flow.

Specifically, here, the first coolant C1 is water, and the second coolant C2 is air. Hence, the first cooling state in which the first coolant C1 for operating the first cooling mechanism 32 is used is different from the second cooling state in which the second coolant C2 for operating at least the second cooling mechanism 34 is used without using the first coolant C1, that is, without operating the first cooling mechanism 32. In addition, the first cooling mechanism 32 and the second cooling mechanism 34 can be operated independently of each other. For example, it is possible to operate the second cooling mechanism 34 without operating the first cooling mechanism 32, or operate the first cooling mechanism 32 without operating the second cooling mechanism 34. Further, it is also possible to operate both the first cooling mechanism 32 and the second cooling mechanism 34, or not to operate the first cooling mechanism 32 and the second cooling mechanism 34. Note that the first coolant C1 and the second coolant C2 may be other materials instead of water and air.

The first cooling chamber 20 also includes a cooling fan 42. The cooling fan 42 is provided in an inner space defined by the furnace partition wall 38 of the tunnel 28. The cooling fan 42 is rotationally driven by a motor 43. In this example, the cooling fan 42 is operated irrespectively of the operations of the first cooling mechanism 32 and the second cooling mechanism 34, but may not be operated.

Note that, in FIG. 2A, the cooling pipe 32a is extended in the coolant channel 33 of the first cooling mechanism 32, and the first coolant C1 is made to flow therein. However, the second coolant C2 may be made to directly flow in the coolant channel 33. FIG. 2B depicts a sectional schematic view of a first cooling chamber 20A according to a modification of the first cooling chamber 20. As depicted in FIG. 2B, in a first cooling mechanism 32A of the first cooling chamber 20A, the coolant channel 33 is connected to a coolant inlet (hereinafter referred to as a first coolant inlet) 32d for the first coolant C1 and a coolant outlet (hereinafter referred to as a first coolant outlet) 32e for the first coolant C1, and the pump 32b for feeding the first coolant C1 under pressure is provided on the upstream side of the first coolant inlet 32d. In the first cooling chamber 20A, the first coolant inlet 32d is formed in the outer wall 36 to introduce the first coolant C1 via a portion of the coolant channel 33 on the lower side in the vertical direction, and the first coolant outlet 32e is formed in the outer wall 36 to feed out the first coolant C1 via a portion of the coolant channel 33 on the upper side in the vertical direction. However, the positions of the first coolant inlet 32d and the first coolant outlet 32e are not limited to the above positions. For example, both the first coolant inlet 32d and the first coolant outlet 32e may be provided at portions of the coolant channel 33 on the upper side in the vertical direction or at portions of the coolant channel 33 on the lower side in the vertical direction. In addition, in the second cooling mechanism 34A of the first cooling chamber 20A, the coolant channel 33 is connected to the second coolant inlet 34b for the second coolant C2 and the second coolant outlet 34e for the second coolant C2, and a pump 40 for feeding the second coolant C2 under pressure is provided on the upstream side of the second coolant inlet 34b. In the first cooling chamber 20A, both the second coolant inlet 34b and the second coolant outlet 34c are provided in the outer wall 36 and at portions of the coolant channel 33 on the upper side in the vertical direction. However, the positions of the second coolant inlet 34b and the second coolant outlet 34c are not limited to the above positions. For example, both the second coolant inlet 34b and the second coolant outlet 34c may be provided at portions of the coolant channel 33 on the lower side in the vertical direction.

Alternatively, one of the second coolant inlet 34b and the second coolant outlet 34c may be provided at a portion of the coolant channel 33 on the lower side in the vertical direction, and the other of them may be provided at a portion of the coolant channel 33 on the upper side in the vertical direction. Also in this case, the first coolant C1 is water, and the second coolant C2 is air. However, the first coolant C1 and the second coolant C2 may be other materials. Hence, the first cooling state in which the first coolant C1 is used and the second cooling state in which the second coolant is used are different from each other. In addition, in the first cooling chamber 20A, the first cooling mechanism 32A and the second cooling mechanism 34A are not simultaneously operated. This is because the coolant channel 33 serves as not only a coolant channel in which the first coolant C1 is made to flow, but also a coolant channel in which the second coolant C2 is made to flow, and the coolant channel in which the first coolant C1 is made to flow and the coolant channel in which the second coolant C2 is made to flow share the channel. In order to switch the coolants flowing through the coolant channel 33, the coolant channel 33 is provided with an unillustrated coolant drain hole, i.e., a water drain hole, in a lower end portion thereof in the vertical direction. Note that the first cooling mechanism 32A and the second cooling mechanism 34A may be configured to circulate corresponding ones of the coolants C1 and C2, or another cooler may additionally be provided. Further, similarly to the first cooling chamber 20 (see FIG. 2A), the first cooling chamber 20A includes the cooling fan 42 rotationally driven by the motor 43. In this example, the cooling fan 42 is also operated irrespectively of the operations of the first cooling mechanism 32A and the second cooling mechanism 34A, but may not be operated.

The second cooling chamber 22 has a configuration for further cooling the workpiece W having passed through the first cooling chamber 20. The second cooling chamber 22 has the same configuration as the first cooling chamber 20 depicted in FIG. 2A, and includes the first cooling mechanism 32, the second cooling mechanism 34, and the cooling fan 42. The second cooling chamber 22 has the same configuration as the first cooling chamber 20, and the above-mentioned modification is similarly applied thereto, and hence, further description thereof is omitted here. However, the second cooling chamber 22 may have a cooling mechanism different from that of the first cooling chamber 20. Here, a coolant (a third coolant) used in the first cooling mechanism 32 of the second cooling chamber 22 is the same as the first coolant C1, and a coolant (a fourth coolant) used in the second cooling mechanism 34 of the second cooling chamber 22 is the same as the second coolant C2. Hence, the second cooling chamber 22 has a third cooling state and a fourth cooling state. In the third cooling state, i.e., the first cooling state, of the second cooling chamber 22, the workpiece W is cooled by use of the third coolant, i.e., the first coolant C1. In the fourth cooling state, i.e., the second cooling state, of the second cooling chamber 22, the workpiece W is cooled by use of not the third coolant but the fourth coolant, i.e., the second coolant C2, different from the third coolant. Note that the third coolant may be different from the first coolant C1, and the fourth coolant may be different from the second coolant C2.

The second cooling chamber 22 may also have the above-mentioned configuration of the first cooling chamber 20A depicted in FIG. 2B. In the case where the second cooling chamber 22 has the above-mentioned configuration of the first cooling chamber 20A depicted in FIG. 2B, the coolant channel 33 serves as not only a coolant channel in which the third coolant is made to flow, but also a coolant channel in which the fourth coolant is made to flow, and the coolant channel in which the third coolant is made to flow and the coolant channel in which the fourth coolant is made to flow share the channel. Here, the third coolant is water as with the first coolant C1, and the fourth coolant is air as with the second coolant C2. However, the third coolant and the fourth coolant may be other materials. In other words, in the case where the second cooling chamber 22 has the above-mentioned configuration of the first cooling chamber 20A depicted in FIG. 2B, the coolant (the third coolant) used in the first cooling mechanism 32A of the second cooling chamber 22 is the same as the first coolant C1, and the coolant (the fourth coolant) used in the second cooling mechanism 34A of the second cooling chamber 22 is the same as the second coolant C2. However, the third coolant may be different from the first coolant C1, and the fourth coolant may be different from the second coolant C2.

The third cooling chamber 24 has a configuration for further cooling the workpiece W having passed through the second cooling chamber 22. The third cooling chamber 24 includes the above-mentioned cooling fan 42. However, the third cooling chamber 24 does not include the first cooling mechanism 32 and the second cooling mechanism 34 described above. The third cooling chamber 24 may have one of or both the first cooling mechanism 32 and the second cooling mechanism 34, which are described with reference to FIG. 2A, or may further have another cooling mechanism. The third cooling chamber 24 may also include the above-mentioned configuration of the first cooling chamber 20A depicted in FIG. 2B, specifically, the first cooling mechanism 32A and the second cooling mechanism 34A. Note that the third cooling chamber 24 itself can be omitted.

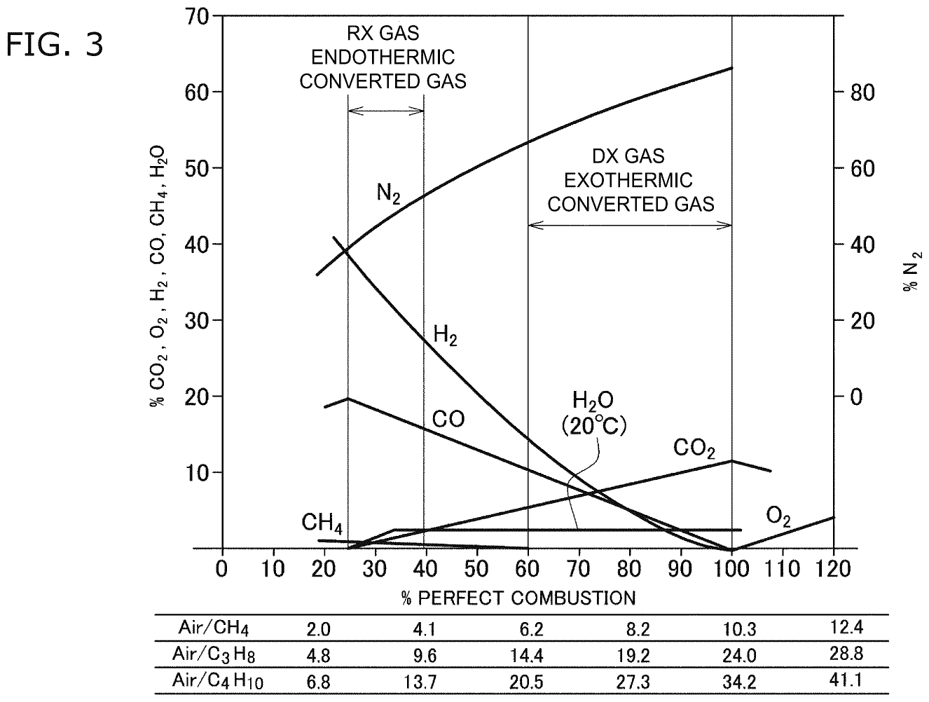

The heat treatment furnace 10 includes an atmosphere gas supply device (hereinafter referred to as a gas supply device) 44. As depicted in FIG. 1, the gas supply device 44 is configured to generate an exothermic converted gas and includes a combustor 44a as a converting furnace which is supplied with a fuel gas and air to generate a converted gas. A mixing ratio of the air and the fuel gas supplied to the combustor 44a is controlled to a predetermined ratio. It is preferable to use, as the fuel gas, a hydrocarbon gas such as methane (CH₄), propane (C₃H₈), and butane (C₄H₁₀). The converted gas generated in this way is a DX gas which is an exothermic converted gas, and contains CO, CO₂, H₂, N₂, and H₂O. FIG. 3 depicts a relation between a mixing ratio of the air and the fuel gas, i.e., a fuel-air ratio, supplied to the converting furnace, i.e., the combustor 44a, of the gas supply device 44 and a component ratio of a converted gas generated upon combustion of the air and the fuel gas. As depicted in FIG. 3, the DX gas contains water (H₂O). According to an aspect of the technology of the present disclosure, by use of the water derived from the DX gas, a bluing treatment or a pseudo-bluing treatment, which will be described later, is performed on the workpiece W.

The converted gas generated by the combustor 44a is supplied to the heat treatment furnace 10 as an atmosphere gas without any change or after being cooled and/or dehydrated if necessary. Here, such a gas is supplied to each of the preheating chamber 14, the heating chamber 16, the retaining chamber 18, the first cooling chamber 20, the second cooling chamber 22, and the third cooling chamber 24. Herein, the combustor 44a as the converting furnace of the gas supply device 44 is disposed in the preheating chamber 14. With this, exhaust heat from the combustor 44a can be used to heat the workpiece W in the preheating chamber 14, whereby heating efficiency in the preheating chamber 14 can be enhanced. The configuration and arrangement of the combustor 44a and the heating process using the exhaust heat from the combustor 44a are disclosed, for example, in Japanese Patent Laid-open No. 2017-166721, and therefore, the detailed description thereof is omitted here.

Various sensors are provided in the heat treatment furnace 10. Although it is preferable that an oxygen sensor capable of measuring oxygen partial pressure be provided, any of other various sensors such as a temperature sensor for measuring a temperature can be provided. For example, a hydrogen sensor for measuring hydrogen partial pressure, a dew point sensor for measuring a dew point in the heat treatment furnace 10, a CO sensor capable of measuring carbon monoxide partial pressure, a CO₂ sensor capable of measuring carbon dioxide partial pressure, and the like may be provided. It is preferable that a controller receive outputs, i.e., detection values, from these sensors and control at least one of the heaters 30, the pump 32b, the pump 40, and the motor 43 on the basis of the outputs. For example, it is preferable that a temperature sensor be provided in each of the burn-off furnace 12, the preheating chamber 14, the heating chamber 16, and the retaining chamber 18 and that the operations of the heaters 30 in each of the chambers 12, 14, 16, and 18 be controlled on the basis of the temperature sensor. In addition, it is preferable that a temperature sensor be provided in each of the first cooling chamber 20, the second cooling chamber 22, and the third cooling chamber 24 and that at least one of the pump 32b, the pump 40, and the motor 43 in each of the chambers 20, 22, and 24 be controlled on the basis of the temperature sensor. Note that the controller includes a processing unit (for example, a central processing unit (CPU)) and a storage unit, i.e., a memory, (for example, a read-only memory (ROM) or a random-access memory (RAM)) and has a configuration of what is called a computer.

Now, the supply of the converted gas from the gas supply device 44 will further be described. FIG. 1 depicts supply ports 50 (50a, 50b, 50c, 50d, 50e, 50f, 50g, 50h, 50i, and 50j) for supplying an atmosphere gas from the gas supply device 44. The first to fourth supply ports 50a to 50d are provided to supply the converted gas to the preheating chamber 14, the heating chamber 16, and the retaining chamber 18. The fifth supply port 50e is provided between the retaining chamber 18 and the first cooling chamber 20 such that the converted gas supplied through the fifth supply port 50e can prevent, for example, mixing of gases between the heating chamber 19 and the first cooling chamber 20. The sixth supply port 50f is provided to supply the converted gas to the first cooling chamber 20. The seventh supply port 50g is provided between the first cooling chamber 20 and the second cooling chamber 22 such that the converted gas supplied through the seventh supply port 50g can prevent, for example, mixing of gases between the first cooling chamber 20 and the second cooling chamber 22. The eighth supply port 50h is provided to supply the converted gas to the second cooling chamber 22. The ninth supply port 50i is provided between the second cooling chamber 22 and the third cooling chamber 24 such that the converted gas supplied through the ninth supply port 50i can prevent, for example, mixing of gases between the second cooling chamber 22 and the third cooling chamber 24. The tenth supply port 50j is provided to supply the converted gas to the third cooling chamber 24.

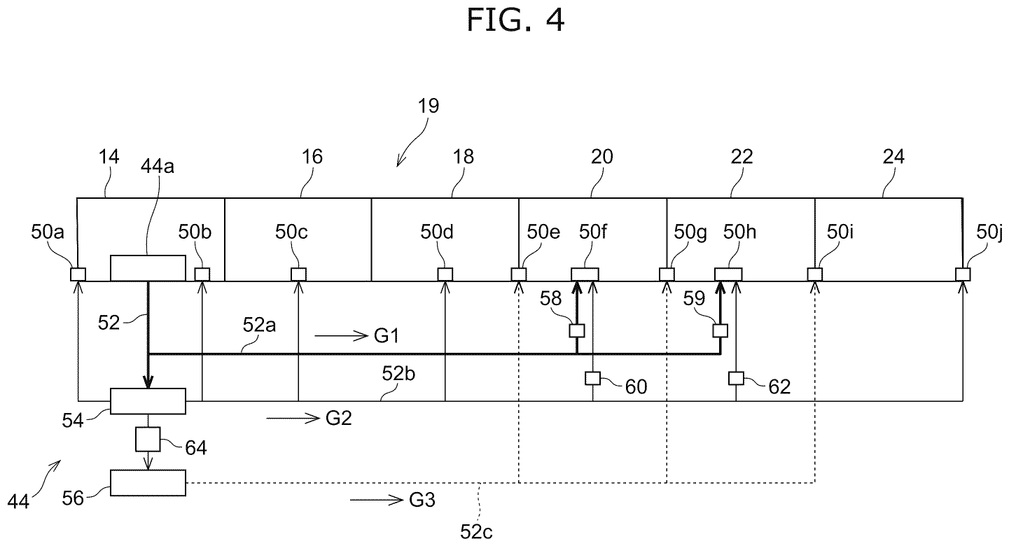

FIG. 4 depicts a flow of the converted gas from the combustor 44a of the gas supply device 44 to each of the supply ports 50. Note that a gas supply channel 52 for the gas supply device 44 and a freeze dehydrator 54 and a dehumidifier 56 that are disposed in the gas supply channel 52, which are depicted in FIG. 4, are omitted from illustration in FIG. 1.

The converted gas generated at the combustor 44a flows through a first branch channel 52a of the gas supply channel 52, and can be supplied to the first cooling chamber 20 via the sixth supply port 50f or supplied to the second cooling chamber 22 via the eighth supply port 50h. The converted gas is a high dew point gas G1, i.e., a first gas, which is a DX gas with a dew point of approximately +40° C., for example.

The water contained in the converted gas generated at the combustor 44a is removed to a certain extent by the freeze dehydrator 54. Then, the converted gas flows through a second branch channel 52b of the gas supply channel 52, and can be supplied to the heating chamber 19, that is, the preheating chamber 14, the heating chamber 16, and the retaining chamber 18, via the supply ports 50a to 50d, supplied to the first cooling chamber 20 via the sixth supply port 50f, supplied to the second cooling chamber 22 via the eighth supply port 50h, or supplied to the third cooling chamber 24 via the tenth supply port 50j. The converted gas has a dew point lower than that of the high dew point gas G1 and is a low dew point gas G2, i.e., a second gas, which is a DX gas with a dew point of approximately 5° C., for example.

The water contained in the converted gas generated at the combustor 44a is further removed by the freeze dehydrator 54 and the dehumidifier 56. Then, the converted gas flows through a third branch channel 52c of the gas supply channel 52, and can be supplied to the fifth supply port 50e, the seventh supply port 50g, and the ninth supply port 50i. This converted gas has a dew point further lower than the dew point of the low dew point gas G2, and is an extra-low dew point gas G3 which is a DX gas with a dew point of approximately −40° C., for example.

A first valve 58 is provided at a portion of the first branch channel 52a through which the high dew point gas G1 is to flow, the portion extending toward the sixth supply port 50f. An upstream end of the first branch channel 52a is connected to a portion of the gas supply channel 52 through which the converted gas itself which is generated at the combustor 44a flows, specifically, is connected to a channel portion extending between the combustor 44a and the freeze dehydrator 54. When the opening of the first valve 58 is adjusted or, for example, the first valve 58 is opened or closed, the flow of the high dew point gas G1 to the sixth supply port 50f can be adjusted. In addition, a second valve 59 is provided at a portion of the first branch channel 52a through which the high dew point gas G1 is to flow, the portion extending toward the eighth supply port 50h. When the opening of the second valve 59 is adjusted or, for example, the second valve 59 is opened or closed, the flow of the high dew point gas G1 to the eighth supply port 50h can be adjusted. Note that the opening of the first valve 58 and the opening of the second valve 59 are manually adjusted here, but they may also be controlled by the above-described controller.

A third valve 60 is provided at a portion of the second branch channel 52b through which the low dew point gas G2 is to flow, the portion extending toward the sixth supply port 50f. In this example, an upstream end of the second branch channel 52b is connected to the freeze dehydrator 54, but may also be connected to a channel portion close to the freeze dehydrator 54 and on the downstream side of the freeze dehydrator 54 or to a channel portion extending between the freeze dehydrator 54 and the dehumidifier 56. When the opening of the third valve 60 is adjusted or, for example, the third valve 60 is opened or closed, the flow of the low dew point gas G2 to the sixth supply port 50f can be adjusted. Further, a fourth valve 62 is provided at a portion of the second branch channel 52b through which the low dew point gas G2 is to flow, the portion extending toward the eighth supply port 50h. When the opening of the fourth valve 62 is adjusted or, for example, the fourth valve 62 is opened or closed, the flow of the low dew point gas G2 to the eighth supply port 50h can be adjusted. Note that the opening of the third valve 60 and the opening of the fourth valve 62 are manually adjusted here, but they may also be controlled by the above-described controller.

Further, a fifth valve 64 is provided between the freeze dehydrator 54 and the dehumidifier 56. When the opening of the fifth valve 64 is adjusted or, for example, the fifth valve 64 is opened or closed, the flows of the extra-low dew point gas G3 to the fifth supply port 50e, the seventh supply port 50g, and the ninth supply port 50i can be adjusted. The fifth valve 64 may be provided at a portion of the third branch channel 52c through which the extra-low dew point gas G3 is to flow. The third branch channel 52c is connected to the downstream side of the dehumidifier 56 and extends toward each of the fifth supply port 50e, the seventh supply port 50g, and the ninth supply port 50i. Note that the opening of the fifth valve 64 is manually adjusted here, but it may also be controlled by the above-described controller.

A heat treatment in the heat treatment furnace 10 configured as above will be described below.

First, the workpiece W to be heat-treated will be described. As has already been described, the workpiece W is an iron core of a motor (a motor core) in this example. A starting material of the workpiece W is an electrical steel sheet, and in a more specific example, it is a non-oriented electrical steel sheet used for a motor core or the like. The starting material may also be an oriented electrical steel sheet used for an iron core of a transformer or the like. The electrical steel sheet is a soft magnetic material and is desirably excellent in magnetic properties and, particularly, low in iron loss.

The non-oriented electrical steel sheet is generally manufactured by a series of processes including pig iron making, steelmaking, hot rolling, and cold rolling, followed by a primary recrystallization and crystal grain growth treatment by continuous annealing. The non-oriented electrical steel sheet thus manufactured is subjected to predetermined blanking, and, for example, a plurality of the resultant sheets are laminated in the die to form a laminate material. The electrical steel sheets are laminated by such a method as welding, adhesion, and/or caulking. As a result, as a workpiece to be subjected to a stress relief annealing treatment in the heat treatment furnace 10, a motor core with a low iron loss can be obtained. However, the workpiece to be heat-treated is not limited to the one manufactured by this method. In addition, the motor core to be heat-treated as described later is not limited to the one laminated in this way and may be an un-laminated one.

Note that the composition of the electrical steel sheet which is to be heat-treated in the heat treatment furnace according to the embodiment of the present disclosure and/or which is used in the heat treatment method according to the embodiment of the present disclosure is not limited to a particular one. For example, a steel sheet defined by JIS C 2552, a steel sheet defined by JIS C 2553, a steel sheet defined by JIS C 2555, and the like can be used preferably. In addition, the sheet thickness of the electrical steel sheet to be used is not limited to a particular thickness.

An oxide film of iron (II) oxide (FeO), triiron tetraoxide (Fe₃O₄), or the like is desirably formed on a surface of the workpiece W to be heat-treated, i.e., the motor core, after the stress relief annealing. Such a treatment for forming the oxide film is the bluing treatment, and the above-mentioned high dew point gas G1 as the first gas is used in the bluing treatment. Note that the bluing treatment is a treatment for blowing a high dew point gas such as water vapor at the time of temperature fall in an annealing furnace, to form the oxide film on the surface of the steel sheet. More specifically, the bluing treatment is a treatment for putting a high dew point gas into a treatment chamber at 350° C. to 550° C. to form the oxide film of iron oxide (II) (FeO), triiron tetraoxide (Fe₃O₄), or the like on the surface of the workpiece W. Note that the bluing treatment may be performed in order to, for example, enhance the corrosion resistance and rust-preventive properties of blanked end faces.

Since the high dew point gas G1 contains water (H₂O) as mentioned above, when the high dew point gas G1 is supplied to at least one of the first cooling chamber 20 and the second cooling chamber 22, the workpiece W can be subjected to the bluing treatment in the at least one cooling chamber. When the bluing treatment is performed, the retaining chamber 18 or the first cooling chamber 20 is adjusted in its heating or cooling capability to cool down to a temperature suitable for the bluing treatment of the workpiece W (the bluing treatment temperature), for example, 500° C.

In addition, when the low dew point gas G2 as the second gas is supplied while the workpiece W is cooled after being heated in the stress relief annealing, characteristics at a comparable level to those obtained when the bluing treatment is performed can be obtained without performing the bluing treatment (see Japanese Patent No. 6944146). This treatment is herein referred to as a “pseudo-bluing treatment.” In the pseudo-bluing treatment, first, the workpiece W heated in the heating chamber 19 is cooled at a cooling rate in excess of 600° C. per hour in at least one of the first to third cooling chambers 20, 22, and 24, for example, in the first cooling chamber 20. It is preferable that the cooling rate be in the range of more than 600° C. per hour but equal to or less than 700° C. per hour (that is, 600° C./h<cooling rate ≤700° C./h), more preferably, in the range of 650° C. to 700° C. per hour. By setting the cooling rate in excess of 600° C. per hour, the time taken for the treatment can be shortened as compared to the cooling rate in related art, that is, a case where the workpiece W is gradually cooled at a rate of approximately 25° C./h.

In this pseudo-bluing treatment, the motor core is cooled at such a cooling rates as described above in the cooling chamber 20, 22, or 24 at least at a temperature used in the treatment (the heating treatment or the annealing treatment) in the heating chamber 19, preferably at a temperature ranging from a soaking temperature (for example, 850° C.) to 500° C. Note that the above-mentioned cooling rate is an average cooling rate in such a temperature range. the motor core may be cooled at a cooling rate in excess of 600° C./h at a temperature ranging from the temperature in the heating treatment to 300° C.

However, at the time of cooling in the first cooling chamber 20 to the third cooling chamber 24, particularly in the first cooling chamber 20 and the second cooling chamber 22, it is preferable that the oxygen partial pressure of the in-furnace cooling atmosphere in the cooling chambers 20, 22, and 24 be set to
equal to or more than the lower one of the oxygen equilibrium partial pressure of 3/2Fe+O₂=1/2Fe₃O₄ and the oxygen equilibrium partial pressure of 2Fe+O₂=2FeO, but
equal to or less than the oxygen equilibrium partial pressure of 4/3Fe+O₂=2/3Fe₂O₃.

The oxygen partial pressure is set in this way to suitably control oxidation of the motor core. This can be understood from the Ellingham diagram representing the standard free energy of formation of iron oxide. To obtain this atmosphere, it is preferable that the operation of the combustor 44a of the gas supply device 44, the mixing ratio of the air and the fuel gas supplied to the combustor 44a, and/or cooling and/or dehydration of the converted gas generated at the combustor 44a, for example, be controlled.

Next, examples of the operation for performing stress relief annealing and an oxide film forming treatment in the heat treatment furnace 10 having the above-mentioned configuration will be described.

### First Example

First, a case where a workpiece W to be heat-treated which is a motor core in which a predetermined number of electrical steel sheets or more are laminated is subjected to the bluing treatment will be described. In this instance, the workpiece W is heated up to the soaking temperature (for example, 850° C.) in the preheating chamber 14 and is then maintained at the same temperature in the heating chamber 16. Since the heaters 30 in the retaining chamber 18 are out of operation, the workpiece W starts being substantially cooled gradually. Also in the first cooling chamber 20 or 20A, the first cooling mechanism 32 or 32A is not operated, but the second cooling mechanism 34 or 34A is operated to cause the second coolant C₂, which is air, to flow through the coolant channel 33, whereby gradual cooling is continued. In other words, the first cooling chamber 20 is in the second cooling state of cooling the workpiece W by use of air as the second coolant without using water as the first coolant. In this instance, the fifth valve 64 is opened such that the extra-low dew point gas G3 is supplied to the first cooling chamber 20 or 20A and that mixing of atmosphere gases between the first cooling chamber 20 or 20A and the second cooling chamber 22 is restrained. As a result, when the workpiece W passes through the first cooling chamber 20 or 20A, the workpiece W is cooled down to a predetermined temperature (for example, 550° C.). Then, in order to subject the workpiece W to the bluing treatment, the second valve 59 is opened to supply the high dew point gas G1 as the in-furnace atmosphere gas to the second cooling chamber 22. In this instance, also in the second cooling chamber 22, the first cooling mechanism 32 or 32A is not operated, but the second cooling mechanism 34 or 34A is operated, whereby the second cooling chamber 22 gets into the fourth cooling state of cooling the workpiece W by use of air as the fourth coolant without using water as the third coolant.

### Second Example

Next, a case where the workpiece W to be heat-treated which is the motor core in which a predetermined number of electrical steel sheets or more are laminated, as with the first example, is subjected to the pseudo-bluing treatment will be described. In this instance, the workpiece W is heated up to the soaking temperature (for example, 850° C.) in the preheating chamber 14 and is then maintained at the same temperature in the heating chamber 16 and the retaining chamber 18. Since the first cooling mechanism 32 or 32A using water as the first coolant C1 is operated in the first cooling chamber 20 or 20A, the workpiece W having passed through the retaining chamber 18 is cooled at a cooling rate higher than the cooling rate in the case of operating the second cooling mechanism 34 or 34A without operating the first cooling mechanism 32 or 32A. Specifically, the workpiece W is cooled at a cooling rate in excess of 600° C./h. Note that, with the first cooling chamber 20 configured as depicted in FIG. 2A, when the first cooling mechanism 32 is operated, the second cooling mechanism 34 is also operated, whereby the first cooling chamber 20 gets into the first cooling state of cooling the workpiece W by use of water as the first coolant. This is similarly applied to the following description. Then, the third valve 60 is opened such that the low dew point gas G2 is supplied to the first cooling chamber 20. As a result, when the workpiece W passes through the first cooling chamber 20 or 20A, the workpiece W is subjected to the pseudo-bluing treatment. Then, also in the second cooling chamber 22, the operation of the first cooling mechanism 32 or 32A and the supply of the low dew point gas G2 by opening the fourth valve 62 are continued as with the first cooling chamber 20, whereby the pseudo-bluing treatment is further performed. In this instance, the second cooling chamber 22 is in the third cooling state of cooling the workpiece W by use of water as the third coolant.

### Third Example

Now, a case where a workpiece W to be heat-treated which is a motor core in which less than a predetermined number of electrical steel sheets are laminated or which is a motor core including one electrical steel sheet is subjected to the bluing treatment will be described. In this instance, the workpiece W is heated up to the soaking temperature (for example, 850° C.) in the preheating chamber 14 and is then maintained at the same temperature in the heating chamber 16 and the retaining chamber 18. In the first cooling chamber 20 or 20A, the first cooling mechanism 32 or 32A is not operated, but the second cooling mechanism 34 or 34A is operated to cause the second coolant C2, which is air, to flow through the coolant channel 33, whereby gradual cooling is performed. Thus, the first cooling chamber 20 or 20A gets into the second cooling state of cooling the workpiece W by use of air as the second coolant without using water as the first coolant. In this instance, the fifth valve 64 is opened such that the extra-low dew point gas G3 is supplied to the first cooling chamber 20 and that, particularly, mixing of atmosphere gases between the first cooling chamber 20 and the second cooling chamber 22 is restrained. As a result, when the workpiece W passes through the first cooling chamber 20 or 20A, the workpiece W is cooled down to a predetermined temperature (for example, 550° C.). Then, in order to subject the workpiece W to the bluing treatment, the second valve 59 is opened to supply the high dew point gas G1 as the in-furnace atmosphere gas to the second cooling chamber 22. In this instance, also in the second cooling chamber 22, the first cooling mechanism 32 or 32A is not operated, but the second cooling mechanism 34 or 34A is operated. As a result, the second cooling chamber 22 gets into the fourth cooling state of cooling the workpiece W by use of air as the fourth coolant without using water as the third coolant.

### Fourth Example

Next, a case where the workpiece W to be heat-treated which is the motor core in which less than a predetermined number of electrical steel sheets are laminated or which is the motor including one electrical steel sheet, as with the third example, is subjected to the pseudo-bluing treatment will be described. In this instance, the workpiece W is heated up to the soaking temperature (for example, 850° C.) in the preheating chamber 14 and is then maintained at the same temperature in the heating chamber 16 and the retaining chamber 18. Since the first cooling mechanism 32 or 32A using water as the first coolant C1 is operated in the first cooling chamber 20 or 20A, the workpiece W having passed through the retaining chamber 18 is cooled at a cooling rate higher than the cooling rate in the case of operating the second cooling mechanism 34 or 34A without operating the first cooling mechanism 32 or 32A. Specifically, the workpiece W is cooled at a cooling rate in excess of 600° C./h. As a result, the first cooling chamber 20 or 20A gets into the first cooling state of cooling the workpiece W by use of water as the first coolant. Then, the third valve 60 is opened such that the low dew point gas G2 is supplied to the first cooling chamber 20 or 20A. As a result, the workpiece W is subjected to the pseudo-bluing treatment by passing through the first cooling chamber 20. Then, the cooling in the second cooling chamber 22 is stopped. In other words, all operations of the first cooling mechanism 32 or 32A and the second cooling mechanism 34 or 34A are stopped. However, in the second cooling chamber 22, the operation of the first cooling mechanism 32 and the supply of the low dew point gas G2 by opening the fourth valve 62 may be continued as with the first cooling chamber 20 or 20A, whereby the pseudo-bluing treatment may further be performed. In this instance, it is preferable that the second cooling chamber 22 be in the third cooling state of cooling the workpiece W by use of water as the third coolant.

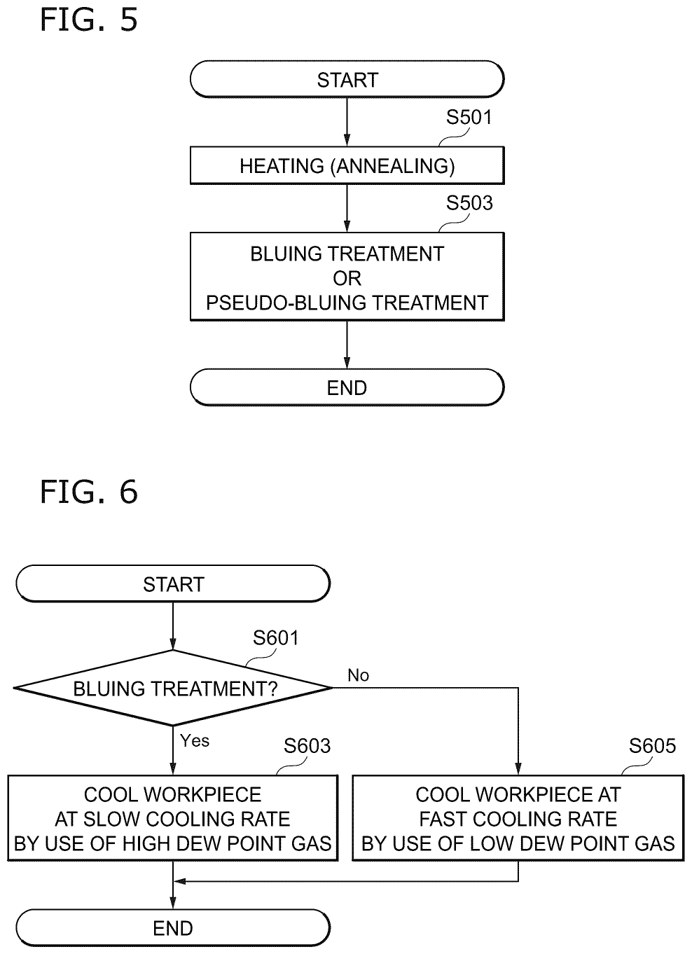

Now, the flow of the heat treatment in the heat treatment furnace 10 is depicted in a flow chart of FIG. 5. As has been described in the first to fourth examples above, the heating treatment, i.e., the annealing treatment, is first performed (step S501). Thereafter, the workpiece W having bean heated is subjected to the bluing treatment or the pseudo-bluing treatment (step S503) according to the characteristics of the workpiece W or the contents of the treatment.

Then, in the first to fourth examples, the use mode of the retaining chamber 18, the first cooling chamber 20 or 20A, and the second cooling chamber 22 has been adjusted according to the number of laminated electrical steel sheets of the motor core which is the workpiece W to be heat-treated. By flexibly changing the use mode in such a manner, more various kinds of workpiece W to be heat-treated in the heat treatment furnace 10 can be used, for example. As has been described in the first to fourth examples above, the heated workpiece W is then subjected to the bluing treatment or the pseudo-bluing treatment (step S503 in FIG. 5). As to the bluing treatment, the workpiece W is first cooled, and the bluing treatment is then performed, as has been described above. The bluing treatment or the pseudo-bluing treatment is selectively performed. This flow will be described on the basis of a flow chart of FIG. 6.

FIG. 6 depicts a flow chart concerning the selection of an in-furnace atmosphere gas and a cooling mechanism used in the cooling chamber 20, 20A, or 22. First, whether or not the bluing treatment is to be performed is determined (step S601). More specifically, step S601 corresponds to a step of determining whether the bluing treatment or the pseudo-bluing treatment is to be performed. Here, the bluing treatment or the pseudo-bluing treatment is selectively performed. Then, in the case where the bluing treatment is to be performed (affirmative determination in step S601), the workpiece W is further cooled at a slow cooling rate by use of the high dew point gas G1 (step S603) in order to perform the bluing treatment. On the other hand, in the case where the pseudo-bluing treatment is to be performed (negative determination in step S601), the workpiece W is cooled at a fast cooling rate by use of the low dew point gas G2 (step S605) in order to perform the pseudo-bluing treatment. Note that the “slow cooling rate” in step S603 and the “fast cooling rate” in step S605 are based on that a cooling rate (corresponding to a first cooling rate) in the operation of the second cooling mechanism 34 or 34A in step S603 is relatively slower than a cooling rate (corresponding to a second cooling rate) in excess of 600° C./h in the operation of the first cooling mechanism 32 or 32A in step S605.

The characteristic configuration of the heat treatment furnace 10 configured as above and the effect thereof will be described below. However, the characteristic configuration of the heat treatment furnace 10 is not limited to the following description.

The above-mentioned heat treatment furnace 10 has a configuration for annealing the workpiece W to be heat-treated. The heat treatment furnace 10 includes the heating chambers 14, 16, 18, and 19 configured to heat the workpiece W, the first cooling chamber 20 or 20A configured to cool the workpiece W having passed through the heating chambers 14, 16, 18, and 19, the second cooling chamber 22 which is located on the downstream side of the first cooling chamber 20 or 20A in the conveying direction D of the workpiece W and which is configured to cool the workpiece W having passed through the first cooling chamber 20 or 20A, and the gas supply device 44 configured to supply an exothermic converted gas as an in-furnace atmosphere gas to each of the first cooling chamber 20 or 20A and the second cooling chamber 22. As has been described above, the first cooling chamber 20 or 20A has the first cooling state of cooling the workpiece W by using the first coolant C1 and the second cooling state of cooling the workpiece W by using not the first coolant C1 but the second coolant C2 different from the first coolant C1. In addition, the second cooling chamber 22 has the third cooling state, i.e., the first cooling state, of cooling the workpiece W by using the third coolant, i.e., the first coolant C1, and the fourth cooling state, i.e., the second cooling state, of cooling the workpiece W by using not the first coolant C1 but the fourth coolant, i.e., the second coolant C2, different from the first coolant C1. Hence, when the stress relief annealing is performed on the workpiece to be heat-treated, which is the motor core, the heat treatment furnace 10 can flexibly cope with the characteristics of the workpiece W or the contents of the treatment as described above.

In addition, the first cooling chamber 20A according to the modification depicted in FIG. 2B includes the switchable cooling mechanisms 32A and 34A which include the common coolant channel 33. The coolant channel 33 serves as the first coolant channel through which the first coolant C1 flows, and also serves as the second coolant channel through which the second coolant C2 flows. In the case where the second cooling chamber 22 has the same configuration as the first cooling chamber 20A, the second cooling chamber 22 similarly includes the switchable cooling mechanisms 32A and 34A which include the common coolant channel 33. The coolant channel 33 serves as the third coolant channel through which the third coolant flows, and also serves as the fourth coolant channel through which the fourth coolant flows. Moreover, the third coolant is the first coolant, and the fourth coolant is the second coolant. In this instance, the switching of the coolants flowing into the common coolant channel 33 is substantially performed by operating one of the pumps 32b and 40 of the cooling mechanisms 32A and 34A and not operating the other of the pumps 32b and 40. This configuration is simpler than that of the cooling mechanisms 32 and 34 of the first cooling chamber 20 depicted in FIG. 2A and thus makes it possible to switch over the cooling rates at the cooling mechanisms 32A and 34A with a lower cost.

Further, the gas supply device 44 is configured to selectively supply the high dew point gas G1, i.e., the first gas, which is an exothermic converted gas, and the low dew point gas G2, i.e., the second gas, which is an exothermic converted gas and which has a dew point lower than the dew point of the high dew point gas G1. Hence, when the workpiece W having passed through the heating chambers 14, 16, 18, and 19 is in the first cooling chamber 20 or 20A or the second cooling chamber 22, the workpiece W can be cooled by use of the high dew point gas G1 or the low dew point gas G2 as the in-furnace atmosphere gas. For example, in the process of the cooling, the bluing treatment or the pseudo-bluing treatment can be performed on the workpiece W. Hence, when the stress relief annealing is performed on the workpiece to be heat-treated, which is the motor core, the heat treatment furnace 10 can flexibly cope with the characteristics of the workpiece W or the contents of the treatment.

For example, the gas supply device 44 can be operated to supply the high dew point gas G1, which is the first gas, to at least either the first cooling chamber 20 or 20A or the second cooling chamber 22 when the workpiece W is subjected to the bluing treatment. Alternatively, the gas supply device 44 can be operated to supply the low dew point gas G2, which is the second gas, to at least either the first cooling chamber 20 or 20A or the second cooling chamber 22 when the workpiece W is subjected to the pseudo-bluing treatment.

Moreover, the heat treatment method in annealing the workpiece W in the heat treatment furnace 10 includes a step of heating the workpiece W (step S501 of FIG. 5) and a step of cooling the heated workpiece W by selectively supplying, as the in-furnace atmosphere gas, the high dew point gas G1 and the low dew point gas G2 (step S503 of FIG. 5). The cooling step (step S503 of FIG. 5) includes a step of supplying the high dew point gas G1 as the in-furnace atmosphere gas and cooling the workpiece W by use of not the first coolant C1 but the second coolant C2 to perform the bluing treatment (step S603 of FIG. 6), and a step of supplying the low dew point gas G2 as the in-furnace atmosphere gas and cooling the workpiece W at a cooling rate in excess of 600° C. per hour by use of the first coolant C1 to perform the pseudo-bluing treatment (step S605 of FIG. 6). As has been described above, the first cooling chambers 20 and 20A include the switchable cooling mechanisms 32 and 34 and the switchable cooling mechanisms 32A and 34A, respectively, and the second cooling chamber 22 similarly includes the switchable cooling mechanisms 32 and 34 or the switchable cooling mechanisms 32A and 34A to implement step S603 and step S605. Further, there is provided the atmosphere gas supply device 44 for selectively supplying the high dew point gas G1 and the low dew point gas G2 to each of the first cooling chamber 20 or 20A and the second cooling chamber 22. Hence, the heat treatment method in the stress relief annealing of the workpiece W in the heat treatment furnace 10 can flexibly cope with the characteristics of the workpiece W or the contents of the treatment.

The typical embodiment of the present disclosure has been described above. However, the present disclosure is not to be limited to the above-described embodiment, and various modifications can be made thereto. Various replacements and modifications can be made insofar as they do not depart from the spirit and scope of the present disclosure defined by the scope of the claims of the present application.

What is claimed is:

1. A heat treatment furnace used to anneal a workpiece to be heat-treated, the heat treatment furnace comprising:
a heating chamber configured to heat the workpiece;
a first cooling chamber configured to cool the workpiece having passed through the heating chamber;
a second cooling chamber that is located on a downstream side of the first cooling chamber in a conveying direction of the workpiece and that is configured to cool the workpiece having passed through the first cooling chamber; and
an atmosphere gas supply device configured to supply, as an in-furnace atmosphere gas, an exothermic converted gas to each of the first cooling chamber and the second cooling chamber,
wherein
the first cooling chamber has a first cooling state of cooling the workpiece by using a first coolant and a second cooling state of cooling the workpiece by using not the first coolant but a second coolant different from the first coolant, and
the second cooling chamber has a third cooling state of cooling the workpiece by using a third coolant and a fourth cooling state of cooling the workpiece by using not the third coolant but a fourth coolant different from the third coolant.

2. The heat treatment furnace according to claim 1, wherein
the first cooling chamber comprises a first coolant channel through which a first coolant flows and a second coolant channel through which a second coolant flows, the first coolant channel having a common part with the second coolant channel, and
the second cooling chamber comprises a third coolant channel through which a third coolant flows and a fourth coolant channel through which a fourth coolant flows, the third coolant channel having a common part with the fourth coolant channel.

3. The heat treatment furnace according to claim 1, wherein
the third coolant is the first coolant, and the fourth coolant is the second coolant.

4. The heat treatment furnace according to claim 1, wherein
the atmosphere gas supply device selectively supplying a first gas that is an exothermic converted gas and a second gas that is an exothermic converted gas and that has a dew point lower than a dew point of the first gas.

5. The heat treatment furnace according to claim 4, wherein
the atmosphere gas supply device is operated to supply the first gas to at least either the first cooling chamber or the second cooling chamber when a bluing treatment is to be performed on the workpiece.

6. The heat treatment furnace according to claim 4, wherein
the atmosphere gas supply device is operated to supply the second gas to at least either the first cooling chamber or the second cooling chamber when a pseudo-bluing treatment is to be performed on the workpiece.

7. The heat treatment furnace according to claim 1, wherein
the workpiece is a motor core.

8. A heat treatment method in annealing a workpiece to be heat-treated, the method comprising:
heating the workpiece; and
cooling the heated workpiece by selectively supplying, as an in-furnace atmosphere gas, a first gas that is an exothermic converted gas and a second gas that is an exothermic converted gas and that has a dew point lower than a dew point of the first gas,
wherein
when a bluing treatment is to be performed, the first gas is supplied as the in-furnace atmosphere gas, and the workpiece is cooled at a first cooling rate by using not a first coolant but a second coolant different from the first coolant, and
when a pseudo-bluing treatment is to be performed, the second gas is supplied as the in-furnace atmosphere gas, the workpiece is cooled at a second cooling rate in excess of 600° C. per hour by using the first coolant, and the second cooling rate is higher than the first cooling rate.
